(19) United States
(12) Patent Application Publication
(10) Pub. No.: US 2005/0131565 A1
(43) Pub. Date: Jun. 16, 2005

(54) Method to control an actuator

(76) Inventors: Joachim Blum, Deizisau (DE); Thomas Megerle, Kirchheim/Teck (DE); Elmar Schneider, Weilheim an der Teck (DE)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/497,373

(22) PCT Filed: Dec. 6, 2002
(86) PCT No.: PCT/EP02/13876

(30) Foreign Application Priority Data
Dec. 8, 2001 (DE) 101 60 477.7

(51) Int. Cl. G06F 7/00; G06F 17/00; G06F 19/00

(52) U.S. Cl. 700/100; 701/56

(57) ABSTRACT

The invention relates to a method for controlling an actuator, such as a device adapted to adjust the hydraulic parameter(s) of a fluid, where the actuator is controlled by a pulse-width modulated signal whose characteristics depend on the parameter(s) to be adjusted. In cases where the actuator needs to be operated with a pulse-width modulated signal whose pulse width is below the actuator's critical pulse width, the pulse-width modulated signal is further modulated with an on-off frequency where the pulse-width is set to at least the actuator's critical pulse width during the “on” phase.

### BACKGROUND

1. Field of Invention

The invention relates to a method for controlling an actuator, also known as a control element. More specifically, the invention relates to a method for controlling an actuator, such as a valve, which is adapted to adjust the hydraulic parameters of a fluid.

2. Description of the Related Art

The use of pulse-width modulated signals to control actuators adapted to adjust hydraulic parameters, such as mass flow and pressure, is well known. Typically, an electronic controller, comprising a pulse-width modulator or pulse-duration modulator, generates the pulse-width modulated signal. The pulse-width modulator typically consists of a saw-tooth shaped signal generator and a comparator. The comparator provides a pulse i.e. triggers the actuator, as long as a control, or ruling, signal is larger than the periodic saw-tooth shaped signal generated by the signal generator. The control signal is typically generated with the help of a controller and reference signals. The signals are usually voltages.

German Patent No. 41 09 233 C2 describes an electronic controller which uses pulse-width modulated output signals to control actuators. More specifically it superimposes, in an AND-gate, a higher-frequency pulse-width modulated signal with the pulse-width modulated output signal.

The hydraulic characteristic adjustment is usually dependent on the pulse width of the pulse-width modulated signal. For example, if the actuator is a pulsating valve used to control the dosing of a liquid, then a shorter pulse width leads to a smaller volume of liquid being metered.

Inherent characteristics of the actuator, such as the inertia of its components, create a lower pulse width limit for the control signal, below which the actuator is unable to react adequately or accurately. Consequently, inherent characteristics of a pulsating valve create a limit on the smallest amount of liquid that can be accurately metered. This lower pulse width limit will be referred to as the critical pulse width in the remainder of this document.

The accurate dosing of small quantities of a fluid therefore requires both complicated control electronics in an electronic controller, as well as an actuator with an appropriate sensitivity, which significantly increases the cost of the dosing device.

There is therefore a need for a method, which extends the operating range of an actuator.

### BRIEF SUMMARY OF THE INVENTION

A method is provided for operating an actuator driven by a pulse-modulated signal. The actuator is effectively operated below its critical pulse width by having the actuator driven by a pulse-modulated signal further modulated with an on-off frequency. The on-off frequency results in the signal having a value alternating between:
a) an on value, that is at or above the actuator's critical pulse width; and
b) zero.

The actuator is adapted to make hydraulic parameter adjustments to a fluid. Pursuant to the method, the combination of the frequency and the on value of the signal driving the actuator is set to provide a similar parameter adjustment to that which would be provided if the actuator could be operated below its critical pulse width.

With regard to apparatus, an actuator driven by a pulse-width modulated signal can be configured so that the pulse-width modulated signal is further modulated with an on-off frequency as described above.

The actuator may be, for example, a pulsating valve and the parameter adjustments may be hydraulic parameter adjustments, such as fluid flow rate or pressure adjustments. The fluid to be adjusted may be, for example, a liquid or gaseous process stream of a fuel cell system.

The method may also comprise the step of determining whether the desired hydraulic parameter adjustment would require the actuator to be operated below its critical is pulse width. The determination of whether the actuator is to be operated effectively below its critical pulse width, can be made in relation to the parameter to be adjusted by the actuator.

The determination of whether the actuator is to be operated effectively below its critical pulse width, can also be made in relation to a factor that dictates the need for a parameter adjustment. For example, a factor that dictates a need for a parameter adjustment (e.g. an adjustment of the rate of reactant supply to a fuel cell system) may be the current, power or energy demanded from a fuel cell system. In another example, where a fuel cell system powers a motor vehicle, a factor which dictates a need for a parameter adjustment may be the vehicle's accelerator pedal position or the rate of change of the vehicle's accelerator pedal position.

A computer program product with program code stored on a machine-readable carrier is also provided. The computer program executes the method outlined above when the program is running on a computer.

A digital storage medium with control signals that can be provided electronically is also provided. The control signals are able to interact and/or cooperate with a programmable computer system such that the method outlined above is carried out.

Many specific details of certain embodiments of the invention are set forth in the detailed description below to provide a thorough understanding of such embodiments. One skilled in the art, however, will understand that the present invention may have additional embodiments, or may be practised without several of the details described.

### BRIEF DESCRIPTION OF THE DRAWINGS

FIG. 1 is a graph illustrating the mass flow rate of a fluid as a function of the pulse width of a pulse-width modulated signal, which is used to control an ideal actuator.

FIG. 2 is a graph illustrating the mass flow rate of a fluid as a function of the pulse width of a pulse-width modulated signal, which is used to control a typical actuator.

FIG. 3a is a graph of the target mass flow rate of a fluid desired to flow through a typical actuator, as a function of time. FIG. 3b-e relate to this graph and have a common time axis.

FIG. 3b is a graph illustrating the control, or ruling, signal, sent to the pulse-width modulator or pulse-duration modulator, as a function of time if a method according to the invention is not applied.

FIG. 3c is a graph illustrating the behaviour or state of a typical actuator in response to the control, or ruling, signal of FIG. 3b.

FIG. 3d is a graph illustrating the control, or ruling, signal, sent to the pulse-width modulator or pulse-duration modulator, as a function of time if a method according to the invention is applied.

FIG. 3e is a graph illustrating the behaviour or state of a typical actuator in response to the control, or ruling, signal of FIG. 3d.

### DETAILED DESCRIPTION OF PREFERRED EMBODIMENTS

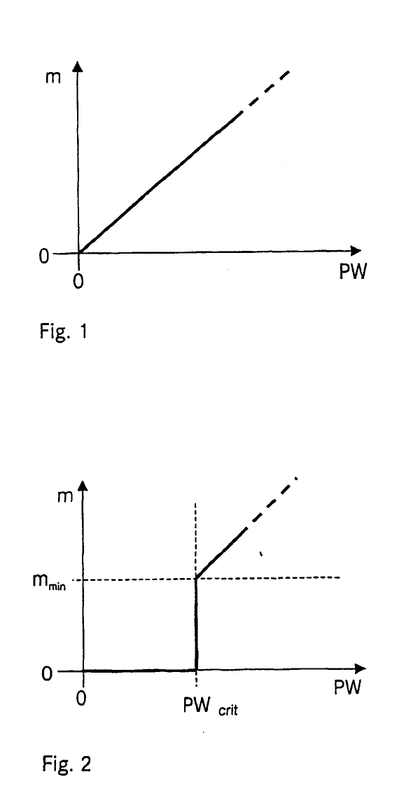

FIG. 1 shows the behaviour of an ideal actuator, more specifically an ideal pulsating valve, for the metering of a fluid. It shows the mass flow rate m of the metered fluid by the ideal actuator as a function of the pulse width PW of the pulse-width modulated control signal received by the actuator.

FIG. 1 shows an upward-sloping straight line, signifying that the mass flow rate m is linearly related to the pulse width PW and increases with the pulse width PW.

FIG. 2 shows the behaviour of a typical actuator, more specifically a typical pulsating valve, for the metering of a fluid. The graph is a somewhat idealised representation of such behaviour. White noise effects, for example, are not shown. Shown is the mass flow rate m of the metered fluid as a function of the pulse width PW. For any pulse width PW that is smaller than a critical pulse width PW_{crit}, the quantity of metered fluid, or its mass flow rate m, is equal to zero. For any pulse width PW that is greater than or equal to critical pulse width PW_{crit}, the characteristic curve takes on an ideal shape, i.e. its shape is that of an upward-sloping straight line with the mass flow rate m being linearly related to pulse width PW. It should be noted that the mass flow rate m might be related to the pulse width PW in a non-linear fashion. Such curve (i.e. flow rate vs. pulse width) is definable and can be computed. Consequently, the minimum mass flow rate mₘᵢₙ that can be set by the actuator is exactly equal to the mass flow rate m that is set when the actuator is triggered with a pulse-width modulated pulse with a critical pulse width PW_{crit}.

The value of the critical pulse width PW_{crit} is dependent on the inherent characteristics of the actuator, for example on the inertia of its components, on the accuracy of its components, on its age, etc.

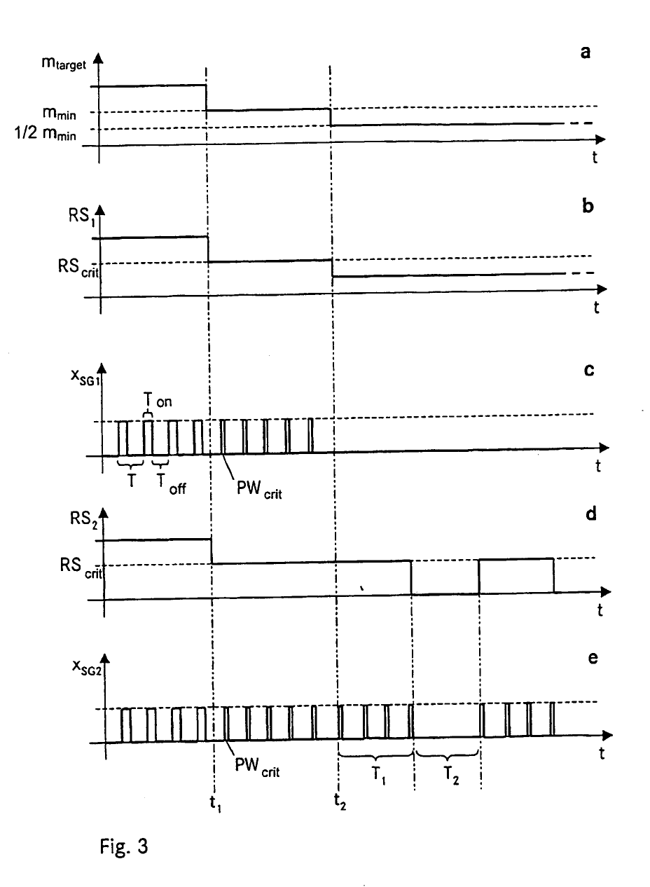

A method pursuant to the invention is explained below with the assistance of FIG. 3.

Diagram “a” shows, as a function of time t, a desired target mass flow rate m_{target} of the metered fluid, preferably a liquid. This target mass flow rate m_{target} is to be set with the help of an actuator, more specifically a pulsating valve.

Diagram “b” of FIG. 3 shows, as a function of time t, the ruling signal RS_{1,} sent to the pulse-width modulator or pulse-duration modulator, to obtain this target mass flow rate m_{target} if the method according to the invention is not applied. Diagram “c” of FIG. 3 shows, as a function of time t, the resulting pulsating valve state X_{SG1} (i.e. if the method according to the invention is not applied). Diagram “d” of FIG. 3 shows, as a function of time t, the ruling signal RS2, sent to the pulse-width modulator or pulse-duration modulator, to obtain this target mass flow rate m_{target} if the method according to the invention is applied. Diagram “e” of FIG. 3 shows, as a function of time t, the resulting pulsating valve state XSG₂ (i.e. if the method according to the invention is applied). A comparison between the ruling signal and a periodic signal generated by a saw-tooth shaped signal generator (not shown) is used to create the pulse-width modulated signal (not shown) that is used to control the actuator.

Target mass flow rate m_{target} is plotted in diagram “a” of FIG. 3 as a function of time t and has the shape of a decreasing step function. At time t₁, target mass flow rate m_{target} drops to Mₘᵢₙ and at time t₂, target mass flow rate m_{target} drops to ½ mₘᵢₙ. The value mₘᵢₙ corresponds to the minimum mass flow rate m (or the minimum quantity) of fluid that can be adequately metered by the actuator which is limited by the inherent characteristics of the actuator.

Diagram “b” of FIG. 3 shows, as a function of time t, ruling signal RS₁ that results if the method according to the invention is not applied. The shape of ruling signal RS₁ corresponds to the shape of target mass flow rate m_{target}, i.e. ruling signal RS₁ is a decreasing step function. During the interval t₁≦t<t₂, ruling signal RS₁ assumes the value of a critical ruling signal RS_{crit}, which corresponds to the minimum mass flow rate mₘᵢₙ that can be set by the actuator. A comparator (not shown) uses ruling signal RS₁ and a periodic signal generated by a saw-tooth shaped signal generator (not shown) to determine the pulses or the pulse-width modulated signal (not shown) that is used to control the actuator and that is responsible for the state of the actuator. The resulting behaviour of the actuator state X_{SG1} is shown in diagram “c” of FIG. 3. Actuator state X_{SG1} alternates between a metering state (X_{SG1}>0) during an ON time interval T_{ON} and a non-metering state (X_{SG1}=0) during an OFF time interval T_{OFF} for as long as target mass flow rate m_{target} is greater than or equal to the minimum settable mass flow rate mₘᵢₙ. This means that for t<t₂, actuator state X_{SG1} behaves like a pulse train, while for t≧t₂ the actuator state X_{SG1} is equal to zero. The pulse width PW and the ON time interval TON are obtained in dependence on the value of ruling signal RS₁. Since for t<t₁ the value of ruling signal RS₁ is larger than the value of the ruling signal for t≧t_{1,} the pulse width PW for t<t₁ will be longer than the pulse width PW for t>′t₁. During the interval t₁<t<t₂ ruling signal RS₁ and pulse width PW or the ON time interval T_{ON} correspond to minimum mass flow rate mₘᵢₙ that can be set by the actuator. This means that the pulse width PW during the interval t₁≦t≦t₂ is the minimum pulse width PW of the pulse-width modulated signal (not shown) that the actuator can adequately react to and corresponds to critical pulse width PW_{crit}. Consequently, for target mass flow rates m_{target} that are smaller than minimum mass flow rate mₘᵢₙ, the pulse width PW will be smaller than critical pulse width PW_{Crit} and the actuator will no longer be able to adequately react to this small pulse width, for example because of inherent characteristics of its components, i.e. no accurate metering of the fluid will take place (in the current embodiment, no metering takes place).

It is customary to specify pulse width PW as a percentage. A pulse width PW of 100% corresponds to an actuator that meters during the entire period T, while a pulse width PW of 0% corresponds to an actuator that does not meter at all. For example, a typical value of PW_{crit} is 4%. If the actuator is driven by a pulse-width s modulated signal with a pulse width PW of 2%, then an ideal actuator would meter the amount of fluid that corresponds to such pulse width, while a typical actuator will no longer operate adequately and will not meter adequately.

Diagram “d” of FIG. 3 shows, as a function of time t, ruling signal RS₂ that results if the present method is applied. When t<t₂, the shape of the curve of ruling signal RS₂ corresponds to that of target mass flow rate m_{target}. During the interval t₁≦t≦t₂, ruling signal RS₂ assumes the value of critical ruling signal RS_{crit}, which corresponds to minimum mass flow rate mₘᵢₙ that can be metered by the actuator. For t≧t₂, ruling signal RS₂ has the value of critical ruling signal RS_{crit} during a first time interval T₁ and is equal to zero during a second time interval T₂. The second time interval T₂ is then again followed by a first time interval T₁ during which RS₂ is equal to RS_{crit}, and so on. This means that for t>t₂, time intervals T₁ and T₂ alternate, with RS₂ equal to RS_{crit} or equal to zero, respectively. Time intervals T₁ and T₂ are chosen so that the integral of RS₂ between t=t₂ and very large time values (t=∞) is equal to the integral of RS₁ between t=t₂ and very large time values (t=∞). A comparator (not shown) uses the periodic signal generated by the saw-tooth shaped signal generator (not shown) to determine pulses or the pulse-width modulated signal (not shown) that is used to control the actuator and that determines the state X_{SG2} of the actuator, the behaviour of which is shown in diagram “e” of FIG. 3. The actuator state X_{SG2} alternates between a metering state (X_{SG2}>0) and a non-metering state (X_{SG2}=0) for as long as target mass flow rate m_{target} is greater than or equal to the minimum settable mass flow rate mₘᵢₙ. Thus, for t<t₂, the actuator behaves like an actuator for which the present method is not being used. During t≧t₂, only half of minimum mass flow rate mₘᵢₙ is to be metered. Consequently, in accordance with ruling signal RS₂, the behaviour of the actuator during first time interval T₁ is the same as during time interval t₁≧t<t₂, i.e. the actuator alternates between a metering state (during the ON time interval T_{ON}) and a non-metering state (during the OFF time interval T_{OFF}). No metering takes place during the second time interval T₂, i.e. the state X_{SG2} is equal to zero. Time intervals T₁ and T₂ alternate during t>t₂.

The integral of the mass flow rate m, which corresponds to the actuator state X_{SG2}, between t=t₂ and t=∞, is equal to the integral of target mass flow rate m_{target} between t=t₂ and t=∞, as long as there are no problems with the metering and/or the actuator control.

In summary, the method according to the invention allows for the control of an actuator adapted to adjust hydraulic parameters, for example a pressure and/or a mass flow rate of a fluid, whereby the actuator is controlled with a pulse-width modulated signal (not shown), the pulse width PW being dependent on a selectable is target value of the hydraulic parameter, for example a target mass flow rate m_{target}. If one wanted to set a value of the hydraulic parameter that would correspond to a pulse width PW of the pulse-width modulated signal that the actuator is unable to adequately react to, i.e. pulse width PW would be smaller than actuator critical pulse width PW_{crit}, then pulse width PW, during a first time interval T₁, would be set to a value that is greater than or equal to critical pulse width PW_{crit} and, during a second time interval T₂, would be set to zero, i.e. during second time interval T₂ the actuator would not be triggered as no ruling signal would be sent to the pulse-width modulator. The second time interval T₂ is preferably longer than one period T of the pulse-width modulated signal minus one ON time interval T_{ON} (i.e. longer than an OFF time interval T_{OFF}).

During time interval t≧t₂, the newly set pulse width PW and time intervals T₁ and T₂ are chosen so that the integral of the pulse-width modulated signal with the newly set pulse width PW over time interval T₁ is equal to the integral of the ideal pulse-width modulated signal over the time interval T₁+T₂. Preferably, time intervals T₁ and T₂, in which the pulse width PW is respectively greater than or equal to critical pulse width PW_{crit} and is set to zero, alternate with each other.

In a preferred embodiment, a determination can be made as to whether the pulse width PW will fall below critical pulse width PW_{crit}. As pulse width PW is dependent on the hydraulic parameter to be adjusted, this determination can be done by relating the target value of the hydraulic parameter to be adjusted with the performance characteristics of the actuator.

In a further preferred embodiment, the actuator is a pulsating valve, which may for example be used in a fuel cell system for the metering of process streams. In a typical fuel cell system, a process stream can be a fuel stream, a hydrogen-rich gas stream or an oxygen-rich gas stream. Fuel cell systems typically use a hydrogen-rich gas stream and an oxygen-rich gas stream to generate electricity. The hydrogen-rich gas stream can be produced from a fuel by means of a reformer unit. Fuels that can be used are for example alcohols, such as methanol, hydrocarbons, ethers, esters, and/or any other substance that can be used to produce a hydrogen-rich gas for the operation of a fuel cell system. A pulsating valve operated pursuant to the present method can control the supply of such streams. During operation, exhaust gases are produced by the fuel cell system. For catalytic combustion purposes, fuel, e.g. methanol, can be added to the exhaust gases by a pulsating valve. If the exhaust gases are being recirculated within the fuel cell system, a pulsating valve can be used for the metering of the exhaust gases. It is also possible to use a pulsating valve to meter the fuel cell system's coolant stream, such as in a de-ionised water-cooling stream.

When the pulsating valve is driven by a pulse-width modulated signal with a pulse width PW that is below critical pulse width PW_{crit}, the value of pulse width PW of the signal is set to the value of critical pulse width PW_{crit}, and the pulsating valve will be triggered or not triggered, respectively, by a pulse-width modulated signal with pulse width PW_{crit} during a first time interval T₁ and by a pulse-width modulated signal with a pulse width equal to zero during a subsequent second time interval T₂.

Time intervals T₁ and T₂ are chosen so that an integration of the metered process streams or exhaust gases over time interval T₁+T₂ yields the same quantity of metered process streams or exhaust gases that would be delivered if an ideal pulsating valve was driven by the original signal with pulse width PW.

For example, if pulse width PW is 2% and critical pulse width PW_{crit} is 4%, then the pulsating valve would be driven for half a second by a pulse-width modulated signal with a pulse width PW of 4% and subsequently for half a second with a pulse-width modulated signal with a pulse width PW of 0%.

As stated previously, it is preferred to be able to predict whether pulse width PW will be below critical pulse width PW_{crit}. This prediction can be made by relating the pulse width PW to the target value of the parameter to be adjusted. Preferably this prediction is done by a computation. For example, the relationship between pulse width PW and the load of the fuel cell system and/or the power, current, or energy demanded from the fuel cell system can be determined. If the fuel cell system is employed in a vehicle, then the relationship between the predicted pulse width PW and the accelerator pedal position or the rate of change of the accelerator pedal position can be determined. The present method may also be used in stationary fuel cell system applications.

The present method offers the advantage that accurate metering, and thus an appropriate control quality, can be achieved even for low load points for which comparatively small quantities of process streams are required to be metered. It therefore becomes possible to achieve a clearly defined and approximately linear behaviour of the pulsating valve throughout the entire desired operating range of the pulsating valve.

Advantageously, the present method can be integrated as a software algorithm into a control unit, e.g. a control device. Thus the method makes it possible to improve an actuator of limited quality or control electronics of limited quality in a cost-effective way by means of this software algorithm.

The use of the present method makes it possible to employ actuators and control units for actuators to meter quantities for which neither the actuators nor the control units were designed. This reduces the expenditures for actuators and/or control units, since for example actuators with wide operating ranges and high resolutions are more expensive than actuators with limited operating ranges and coarse resolutions.

While particular elements, embodiments and applications of the present method have been shown and described herein, it will be understood, of course, that the invention is not limited thereto since modifications may be made by those skilled in the art, particularly in light of the foregoing teachings.

It is therefore contemplated by the appended claims to cover such modifications as incorporate those features, which come within the scope of the invention.

1. A method to control an actuator for setting a hydraulic parameter, whereby the actuator is controlled by a pulse-width modulated signal, the pulse width (PW) of which is dependent on a selectable target value of the hydraulic parameter, and whereby, if the pulse width (PW) is below a critical pulse width (PW_{crit}), the value of the pulse width (PW) during a first time interval (T₁) is set to a value greater than or equal to the critical pulse width (PW_{crit}), and during a second time interval (T₂) that follows after the first time interval (T₁) the pulse width PW is set to zero and the actuator is not triggered.

2. The method of claim 1 whereby the second time interval (T₂) is longer than one period (T) of the pulse-width modulated signal minus one ON time interval (T_{ON}).

3. The method of claim 2, wherein it is determined whether the pulse width (PW), which depends on a selectable target value of the hydraulic parameter, is smaller than the critical pulse width (PW_{crit}).

4. The method of claim 3, the determination of whether the pulse width (PW) is below the critical pulse width (PW_{crit}) takes place in dependence on performance quantities that determine the target value of the hydraulic parameter.

5. The method of claim 2, wherein if the pulse width would be smaller than the critical pulse width (PW_{crit}), then the pulse width (PW) and the time intervals (T₁) and (T₂) are chosen so that the integral of the pulse-width modulated signal with the re-determined pulse width (PW) over the first time interval (T₁) corresponds to the integral of the original pulse-width modulated signal over the first and the second time interval (T₁+T₂).

6. The method of claim 2, wherein if the pulse width would be smaller than the critical pulse width (PW_{crit}), the time intervals (T₁) and (T₂), during which the pulse width (PW) is greater than or equal to the critical pulse width (PW_{crit}) or is set to zero, follow each other in an alternating fashion.

7. The method of claim 1, wherein the actuator is a timing valve.

8. The method of claim 7, used for the metering of an operating material and/or exhaust gas in a fuel cell system that takes place by means of a timing valve that is controlled by a pulse-width modulated signal.

9. The method of claim 8, wherein as soon as the timing valve is driven by a pulse-width modulated signal with a pulse width (PW) that is below the critical pulse width (PW_{crit}), the value of the pulse width of the signal is replaced by the value of the critical pulse width (PW_{crit}) and the timing valve during a first time interval (T₁) is triggered by the pulse-width modulated signal with the critical pulse width (PW_{crit}) and during a subsequent second time interval (T₂) is not triggered by a pulse-width modulated signals with a pulse width (PW) that is equal to zero.

10. The method of claim 9, wherein the time intervals (T₁) and (T₂) are chosen so that an integration of the metered fuel quantity over the time of the first and the second time interval (T₁+T₂) yields the same quantity of metered fuel as if an ideal timing valve was controlled by the original pulse-width modulated signal.

11. The method of claim 10, wherein it is determined whether the pulse width (PW) is below the critical pulse width (PW_{crit}) and in that the predictive determination takes place in dependence on a load of the fuel cell system and/or on the current, power, or energy that is demanded from the fuel cell system.

12. The method of claim 11, wherein the fuel cell system is used in a vehicle and that the predictive determination takes place in dependence on the position of the accelerator pedal and/or the movement of the accelerator pedal.

13. The method of claim 1, wherein the actuator is a pulsating valve and the parameter adjustments are hydraulic parameter adjustments.

14. The method of claim 1, wherein the hydraulic parameters are fluid flow rate or pressure adjustments.

15. The method of claim 14, wherein the fluid for which the hydraulic parameter is to be set is a process stream of a fuel cell system.

16. A computer program product with program code stored on a machine-readable carrier for executing the method of any of claims 1 to 15 when the program is running on a computer.

17. A digital storage medium with control signals that can be read out electronically, the control signals being able to interact and/or cooperate with a programmable computer system such that a method of any of claims 1 to 15 is carried out.
